(19) United States
(12) Patent Application Publication
(10) Pub. No.: US 2012/0297999 A1
(43) Pub. Date: Nov. 29, 2012

(54) PRINTING METHOD AND OFFSET PRINTING UNIT

(75) Inventors: BERNARD BEIER, LADENBURG (DE); WOLFRAM KOLBE, HEIDELBERG (DE); MARTIN MAYER, LADENBURG (DE); HEINER PITZ, WEINHEIM (DE); MATTHIAS SCHLÖRHOLZ, PLANKSTADT (DE); JOHANN WEIGERT, GETTORF (DE)

(73) Assignee: HEIDELBERGER DRUCKMASCHINEN AG, HEIDELBERG (DE)

(21) Appl. No.: 13/480,591

(22) Filed: May 25, 2012

(30) Foreign Application Priority Data
May 25, 2011 (DE) 10 2011 102 382.1
Sep. 5, 2011 (DE) 10 2011 112 487.3

(51) Int. Cl. B41F 31/26; B41F 23/04; B41F 3/34

(52) U.S. Cl. 101/367; 101/492; 101/487

(57) ABSTRACT

A printing method in a printing press includes zonally metering a printing ink at a first viscosity with a metering device and transferring the printing ink at a second viscosity with a printing form cylinder, in which the second viscosity is greater than the first viscosity. An offset printing unit for implementing the method is also provided.

### CROSS-REFERENCE TO RELATED APPLICATION

This application claims the priority, under 35 U.S.C. §119, of German Patent Applications DE 10 2011 102 382.1, filed May 25, 2011 and DE 10 2011 112 487.3, filed Sep. 5, 2011; the prior applications are herewith incorporated by reference in their entirety.

### BACKGROUND OF THE INVENTION

### Field of the Invention

The present invention relates to a printing method and to lithographic offset printing units that are suitable for implementing the method.

Inking units for planographic offset printing are constructed either as short inking units without zones or as inking units with zonal ink metering. Short inking units without zones include an anilox roller. Inking units with zonal ink metering include an ink fountain that has a metering device with ink zones. Those ink zones are disposed adjacent each other across the printing width and enable different ink metering from ink zone to ink zone. The ink zones may be formed by ink zone screws.

In web-fed printing presses, the inking units that have zonal metering are constructed as film-type inking units in which an ink fountain roller and a film roller form a film nip that may be 0.05 mm wide, for example. Due to the film nip, the film roller is not engaged with the ink fountain roller. The film roller rotates at a higher speed than the ink fountain roller and takes off the uppermost layer of an ink film on the ink fountain roller to receive ink from the ink fountain roller.

In sheet-fed printing presses, inking units that have zonal metering are constructed as vibrator-type inking units. In a vibrator-type inking unit, the ink is transferred from the ink fountain roller to a vibrator roller. The vibrator roller is not in continuous contact with the ink fountain roller, rather contact between those rollers is discontinuous. The vibrator roller periodically contacts the ink fountain roller to receive ink from the latter.

Short zone-free inking units (inking units without metering devices that include ink zones) that do not include an anilox roller are also known in the art. German Patent Application DE 102006061393 A1 describes a short inking unit without ink zones in which a roller and a metering roller form a metering nip that is 20 μm wide. The roller rotates at the same circumferential speed as the printing form cylinder. Cooling devices are provided for the roller and the printing form cylinder. The described short inking unit is constructed for applications using high-viscosity printing inks.

All known types of lithographic offset printing units, whether they are part of a web-fed press or a sheet-fed press, whether they include a zonal inking unit, an inking unit without zones, a film-type inking unit, or a vibrator-type inking unit, have one specific characteristic. That specific characteristic is that when the ink is metered, for example through the use of the anilox roller or the zonal metering device, the viscosity of the ink is higher than when the ink is present on the printing form cylinder. Offset printing ink is thixotropic. Consequently, the viscosity of the offset printing ink is reduced as it is subjected to rheological stress in the roller nips of the inking unit on its metering path to the printing form cylinder.

### SUMMARY OF THE INVENTION

It is accordingly an object of the invention to provide a further printing method and a suitable offset printing unit for implementing the method, which overcome the hereinafore-mentioned disadvantages of the heretofore-known methods and devices of this general type.

With the foregoing and other objects in view there is provided, in accordance with the invention, a printing method for a printing press. The printing method comprises zonally metering a printing ink at a first viscosity with a metering device, and transferring the printing ink at a second viscosity, being greater than the first viscosity, with a printing form cylinder.

There is a fundamental difference between the printing method of the invention and the prior art printing methods, in which the second viscosity is lower than the first viscosity. In accordance with the printing method of the invention, the viscosity of the printing ink is lower when the ink is zonally metered than in its condition on the printing form cylinder. The low first viscosity reduces the hydrodynamic stress that the ink applies to the metering device, thus increasing the degree of precision of the zonal metering. The higher second viscosity results in a particularly sharp separation of printing areas and non-printing areas on the printing form cylinder and prevents the non-printing areas from receiving ink (a phenomenon sometimes referred to as toning).

In accordance with a first aspect of the invention, the printing method may be a direct printing method. In accordance with a second aspect of the invention, the method may be an indirect printing method. If the method is a direct printing method, the printing ink is directly transferred from the printing form cylinder to the printing substrate. In an indirect printing method, the printing form cylinder transfers the ink to a transfer cylinder (blanket cylinder), which then transfers the ink to the printing substrate, which may be a web of printing material or, preferably, a sheet of printing material.

In accordance with another mode of the method of the invention, the second viscosity is at least ten times higher than the first viscosity. For instance, the first viscosity may be less than 1 pascal-second and the second viscosity may be more than 10 pascal-seconds.

In accordance with a further mode of the method of the invention, the first viscosity may be adjusted by reducing the viscosity of the printing ink in the printing press and/or the second viscosity of the printing ink may be adjusted by increasing the viscosity of the printing ink in the printing press.

The reduction of the viscosity may be achieved by heating the printing ink. An increase of the viscosity may, for example, be achieved by cooling the printing ink.

With the objects of the invention in view, there is also provided an offset printing unit, comprising an ink fountain having a metering device with ink zones, an ink fountain roller, an inking unit roller in continuous engagement with the ink fountain roller, and a printing form cylinder, in which the ink fountain roller and the printing form cylinder are driven in such a way that they have the same circumferential speed. In accordance with various alternatives of the lithographic offset printing unit of the invention, the ink fountain roller may be equipped with a heating device and/or the printing form cylinder may be equipped with a cooling device. The heating device of the ink fountain roller may heat the printing ink to reduce the viscosity of the printing ink in order for the printing ink to have a reduced viscosity as it is zonally metered by the metering device. The cooling device of the printing form cylinder may cool the printing ink to increase its viscosity in order for the printing ink to have an increased viscosity on the printing form cylinder.

The invention and its further developments provide ways of controlling the viscosity of the ink in a targeted way. The control may be carried out in such a way as to ensure that in the ink metering region, the viscosity of the ink is low, for instance less than one pascal-second. Furthermore, the control of the viscosity of the ink may be accomplished in such a way as to ensure that in the image forming region, i.e. on the printing form cylinder, the viscosity of the ink is comparatively high, for instance more than 10 pascal-seconds. The viscosity difference between the ink metering region and the image forming region and, to be more precise, the increase in viscosity from the ink metering region to the image forming region, may be achieved in various ways. For instance, the low viscosity in the ink metering region may be a given fact because the viscosity of the printing at room temperature is low anyway even without any temperature-control measures. Alternatively, the low viscosity in the ink metering region may be the result of a specific reduction of the viscosity of the ink. This reduction may be achieved by heating the printing ink. The reduction may likewise be achieved by increasing the inking unit speed and/or by generating a relative movement, which has a heating and smoothing effect. Another way to reduce the viscosity of the ink may be to add drops of water or dampening solution. In addition, the viscosity may be reduced by subjecting the printing ink to ultrasound. Due to the reduced viscosity of the ink, the ink may be metered at machine speed, and the use of a vibrator roller or of a film roller is no longer required. In addition, the inking unit may be as short as an anilox inking unit. In contrast to such an anilox inking unit, however, in the inking unit of the invention, the ink metering may be zonally varied across the entire printing width. Due to the high circumferential speed of the ink fountain roller, a blade-type ink fountain is preferred as an ink metering device. The ink zones of the blade-type ink fountain may be formed by ink keys that bend a metering blade of the blade-type ink fountain to different extents in the individual ink zones. The ink keys may be driven by hand or by a motor.

In order to ensure that the viscosity of the ink is comparatively high in the image forming region (on the printing form cylinder), for instance more than 10 pascal-seconds, the viscosity of the ink may be increased in various ways. One way of increasing the viscosity of the ink is to cool the printing ink. Another way of increasing the viscosity of the ink is to evaporate a carrier liquid from the printing ink. In addition, the printing ink may be or contain an electrorheological fluid and the viscosity may be increased by an electric field. Furthermore, a specific evaporation of components of the printing ink may be effected to increase the viscosity of the ink.

In order to achieve an increased viscosity of the ink from the ink fountain to the printing form cylinder it is possible to use an ink that has a low-viscosity carrier liquid that evaporates on the printing form cylinder. In addition, ink components may be melted and thus cross-linked on the printing form cylinder to obtain an additional increase in viscosity. The printing ink may likewise include an infrared (IR) absorber or a near-infrared (NIR) absorber or UV photoinitiators that absorb IR laser radiation or NIR laser radiation or UV radiation (generated by a UV source, a UV LED or a UV laser) to achieve a controlled increase in viscosity. The increased viscosity may be based on physical effects (in particular evaporation or accelerated volatilization) or on chemical cross-linking. It may be necessary to remove the evaporated or volatilized ink components by suction and thus to provide a suitable suction device in the printing unit. In the case of chemical cross-linking, which may be caused by the UV radiation, the use of an inerting system may be expedient.

A zonally controllable light source or laser source may be provided to provide zonal viscosity control. The light or laser source may preferably be actuated in wide zones, but it may also be actuated precisely in accordance with the printed image if desired. The actuation may occur both in the direction of rotation of the printing form cylinder and perpendicular to the direction of rotation.

The lithographic offset printing unit of the invention may be a printing unit for wet-offset printing. In wet-offset printing, a defined amount of dampening solution needs to emulsify into the printing ink to avoid dot touch, a defect that would otherwise occur in respective very dense screens and dot screens such as 80% screens. In order to prevent dot touch despite the relatively high degree of viscosity of the printing ink on the printing form cylinder as proposed by the invention, the printing ink may have an increased water content or an additive that improves emulsification with the dampening fluid. A further method is to provide an inking unit that is formed of more than three rollers, for instance of a maximum of four to six rollers, to improve the emulsification in a sufficient way. The inking unit may, for example, include only two ink form rollers rolling off on the printing form cylinder during printing. Compared to a conventional anilox inking unit, such an inking unit would be more efficient in terms of emulsification. Compared to conventional vibrator-type inking units and conventional film-type inking units, the inking unit of the invention would be less expensive to manufacture because it contains fewer rollers.

A further way of rendering the printing ink more viscous on the printing form cylinder than in the ink fountain is to cross-link ink components, for instance by melting latex particles, by partial curing through the use of UV radiation, or by precipitating ink components. If latex or synthetic resin dispersions on a styrene butadiene basis or on a styrene methacrylate basis or on a different polymeric basis are used to form the printing ink, a viscosity increase can be attained in various ways. For instance, the printing form cylinder may be heated. In the case of aqueous dispersions, this would cause an increase in the concentration of the particles and thus a fusing of the individual polymeric particles on the hand and would lead to the creation of a continuous ink film of high viscosity when a minimum film-forming temperature is exceeded. In other cases, the viscosity of the ink dispersion may be increased to a considerable extent by contact with multivalent cations. In such a case, multivalent cations such as divalent calcium cations or divalent magnesium cations or trivalent aluminum cations, for instance in the form of aqueous solutions or fluorides or sulfates or nitrates thereof would be applied to the surface of the printing form cylinder, i.e. to the printing form. Upon contact with the printing ink, ionic clusters will form, which considerably increase the viscosity of the printing ink. Increasing the viscosity by adding acids would also be conceivable. If acrylate-based UV printing inks are used, the viscosity increase can be achieved by a partial curing of the printing ink using UV radiation. In this context, the intensity and the wavelength range of the UV radiation would be selected in such a way as to ensure that only a very low degree of cross-linking is caused due to the formation of only a few links on the surface of the ink. This ensures that the viscosity is increased without causing the ink to adhere to the printing form cylinder.

Another way of controlling the viscosity of the printing ink in such a way as to ensure that it has a lower viscosity when it is zonally metered by the metering device than when it is transferred by the printing form cylinder is to use a printing ink that includes latent heat storage particles, also known as phase change particles (PCM) such as paraffin. PCMs are based on the principle that the material can absorb a large amount of thermal energy upon a phase change from solid to liquid and can give off this energy at a later time. For example, paraffin is liquid at temperatures above 26° C. and cannot absorb any more energy above this temperature. A capsule effect guarantees reversibility and prevents paraffin from leaking out. If the PCM is a component of the printing ink, a special “temperature comfort range” would have to be defined specifically for the printing press. By adding the latent heat storage particles to the printing ink, the latter would be able to store latent heat. The stored thermal energy can be dissipated with the ink through the printing substrate to counteract a further temperature increase and thus a reduction of the viscosity of the ink in the inking unit. Influencing the viscosity of ink by using latent heat storage particles contained in the printing ink may be combined with other methods of changing the viscosity of the ink, for instance using ultrasound. This is a way to adjust the viscosity of the printing ink independently of temperature effects.

German Patent Application DE 103 06 939 A1 discloses an offset printing ink that includes a PCM. The PCM described therein experiences a phase change from solid to liquid, may be encapsulated and may be present as a paraffin, for instance. The offset printing ink includes the PCM to render the components (such as tarpaulin) coated with the offset printing ink capable of storing heat on their surfaces. The document describes that for this purpose, a close connection between the PCM and the component is necessary. A specific dissipation of heat from an inking unit for offset printing using the PCM is not described.

Furthermore, European Patent Application EP 2 087 998 A1, corresponding to U.S. Patent Application Publication No. US 2009/0202936 A1, discloses a rubber jacket for a roller. The rubber jacket includes a PCM for heat-regulation purposes. That document does not describe the dissipation of heat through the use of the PCM either.

The storage and dissipation of heat from a printing unit using a PCM can preferably be attained by the following method: A method of dissipating thermal energy form a printing unit including the steps of providing a printing ink that contains a substance (preferably a PCM), the substance being in a first state in the printing unit at a first point in time, and the substance being in a second state in the printing unit at a second point in time, causing the substance to experience a phase change between the first and the second state between the first point in time and the second point in time and to absorb thermal energy in the process, dissipating thermal energy from the printing unit with the substance.

PCMs that are suitable for the method have a phase change temperature of between approximately 20° C. and approximately 50° C. (between approximately 68° F. and 122° F.) and a particle size of between approximately 0.1 μm and 50 μm. The concentration of the PCM in the offset printing ink is preferably between approximately 5% by weight and approximately 40% by weight.

The PCM (latent heat storage unit) is preferably a paraffin and is preferably added to the printing ink in an encapsulated form. Such encapsulated paraffins are available, for instance, from the BASF Company under the trade name Micronal®. They typically have a size of between 2 and 20 μm and a maximum heat capacity of approximately 110 kJ/kg. Such a PCM can be dispersed in known offset printing ink to be used in the method described above. The preferred mass proportion of weight is approximately 10% by weight. A suitable offset printing ink is, for example, K+E Novastar® F 912 MAGIC BIO. In this example, the storage capacity of the printing ink is approximately 11 kJ/kg. At a common heat capacity of offset printing inks of approximately 1.5 to approximately 2.5 kJ/Kelvin×kg, the heat storage of the PCM capsules compensates a temperature increase of the printing ink by approximately 4.4 to approximately 7.3 Kelvin that would otherwise occur. Preferred PCM particles are Micronal® DS 5000× at a capsule diameter of 5 μm and a phase change temperature of approximately 26° C. (approximately 78.8° F.).

The encapsulated PCM particles may also assume other functions in the offset printing ink. For instance, the capsules may act as spacer particles and abrasion protection particles. If used as spacer particles, the particles preferably have a size of between approximately 1 μm and approximately 50 μm and a mass weight proportion of approximately 0.5 to 5% by weight.

In addition to being used in offset printing inks, the particles may also be used in flexographic printing inks, UV printing inks, varnishes and even directly in the printing material.

Other features which are considered as characteristic for the invention are set forth in the appended claims.

Although the invention is illustrated and described herein as embodied in a printing method and an offset printing unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, sectional view of a lithographic offset printing unit including a heated ink fountain roller;

FIG. 2 is a fragmentary, sectional view of a lithographic offset printing unit with a cooled printing form cylinder;

FIG. 3 is a fragmentary, sectional view of a lithographic offset printing unit with a heated ink fountain roller and a cooled printing form cylinder; and

FIG. 4 is a fragmentary, sectional view of a lithographic offset printing unit with a radiation source directed toward printing ink on the printing form cylinder.

### DETAILED DESCRIPTION OF THE INVENTION

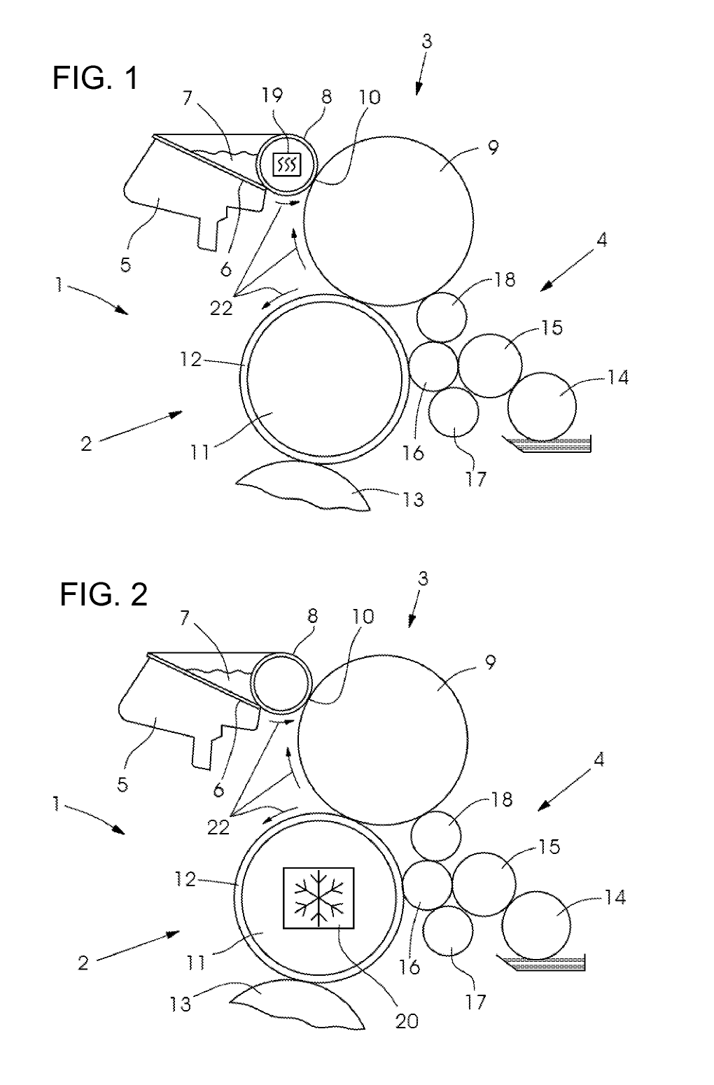

Referring now in detail to FIGS. 1 to 4 of the drawings as a whole, in which corresponding elements and components are identified by identical reference symbols, there are seen different embodiments which have various features in common and in which each of the figures illustrates a section of a printing press 1. The printing press 1 is a sheet-fed printing press. The illustrated section is a planographic offset printing unit 2 of the printing press 1. The offset printing unit 2 includes an inking unit 3 and a dampening unit 4. The inking unit 3 includes an ink fountain 5 with an ink zone metering device 6 for zonal metering of a printing ink 7 stored in the ink fountain 5. The zonal ink metering varies across the printing width (perpendicular to the plane of the image of FIGS. 1 to 4).

The zonal ink metering device 6 includes ink zones that are disposed adjacent each other in a line parallel to an axis of rotation of an ink fountain roller 8. The ink zones may be formed by ink keys, screws, metering slides, metering levers, or metering tabs. The ink zone metering device 6 may include a metering blade that is subdivided into the metering tabs. The zonal ink metering device 6 and the ink fountain roller 8 define a metering nip for metering the printing ink 7. The width of the metering nip may be varied from ink zone to ink zone by adjusting the metering elements (metering slides, metering levers, metering tabs) or by adjusting ink keys that act on the metering blade. Such a zonal adjustment is done as a function of the image to be printed to create a corresponding ink profile in the ink film that is formed on the ink fountain roller 8 as a result of the zonal ink metering.

The ink fountain roller 8 interacts with an inking unit roller 9 that is in continuous engagement with the ink fountain roller 8 in a roller contact point 10 during printing. The inking unit roller 9 is an ink form roller that rolls on a printing form cylinder 11 during printing to apply ink to a lithographic offset printing form 12 mounted to the cylinder. The length of the outer circumference of the inking unit roller 9 is substantially the same as the length of the outer circumference of the printing form cylinder 11. The printing form cylinder 11 or rather the offset printing form 12 mounted thereon transfers the printing ink located thereon to a transfer or blanket cylinder 13. The blanket cylinder 13 transfers the printing ink it has received to a (non-illustrated) sheet-like printing substrate to create a printed image thereon.

The dampening unit 4 includes a dipping roller 14 and a metering roller 15 engaged with the dipping roller 14 and with a dampening form roller 16. An axially oscillating distributor roller 17 is in engagement with only the dampening form roller 16. A bridge roller 18 is simultaneously in engagement with the dampening form roller 16 and the inking unit roller 9. The aforementioned roller engagements refer to the condition in a printing operation.

The ink fountain roller 8, the inking unit roller 9 and the printing form cylinder 11 are driven to rotate in such a way that these three rotating bodies 8, 9, 11 rotate at the same circumferential speed 22 during printing. The ink fountain roller 8 and the inking unit roller 9 rotate in opposite directions of rotation. In the example shown in FIGS. 1 to 4, the inking unit roller 9 rotates in a clockwise direction and the ink fountain roller 8 rotates in a counter-clockwise direction. The point of roller contact 10 is a pressure nip in which the inking unit roller 9 is pressed against the ink fountain roller 8 or the ink fountain roller 8 is pressed against the inking unit roller 9.

In the following, the particularities of the individual exemplary embodiments will be described separately.

In the exemplary embodiment of FIG. 1, a heating device 19 is provided. The heating device 19 heats the printing ink 7 in the ink fountain 5. The heating device 19 is integrated into the ink fountain roller 8 and may be formed by a temperature control medium channel for a heating fluid such as warm water. The heating device 19 heats the circumferential surface of the ink fountain roller 8, which is in contact with the printing ink 7 in the ink fountain 5, thus heating the printing ink 7. The heating of the printing ink 7 results in a reduction of its viscosity. Thus, the printing ink 7 has a comparatively low viscosity when the printing ink 7 is metered by the zonal ink metering device 6.

After the metering, the printing ink gives off heat to the environment, for instance to the inking unit roller 9. As a consequence, the viscosity of the ink will re-increase. As a result of the cooling effect, when the printing ink 7 reaches the printing form cylinder 11 or rather the offset printing form 12 mounted thereon, its viscosity is higher than the viscosity of the printing ink 7 in the ink fountain 5. This higher viscosity will preferably have been attained already at the instant of the transfer of the printing ink from the inking unit roller 9 to the printing form cylinder 11 or rather to the offset printing form 12 mounted thereon or when the printing ink is transferred from the printing form cylinder 11 or rather from the offset printing form 12 mounted thereon to the blanket cylinder 13 at the latest.

In the exemplary embodiment shown in FIG. 2, a cooling device is provided to cool the printing ink 7 on the printing form cylinder 11, i.e. on the printing form 12. The cooling device 20 is integrated into the printing form cylinder 11 and may be formed by a temperature control medium channel for a cooling fluid such as cooling water. The cooling device 20 cools the printing form cylinder 11 and thus the offset printing form 12 and the printing ink 7 present thereon. Due to the cooling effect, the viscosity of the printing ink 7 on the printing form cylinder 11, i.e. on the offset printing form 12 mounted thereon, is increased to a level above the viscosity of the same printing ink in the ink fountain 5, i.e. when it is metered by the zonal ink metering device 6.

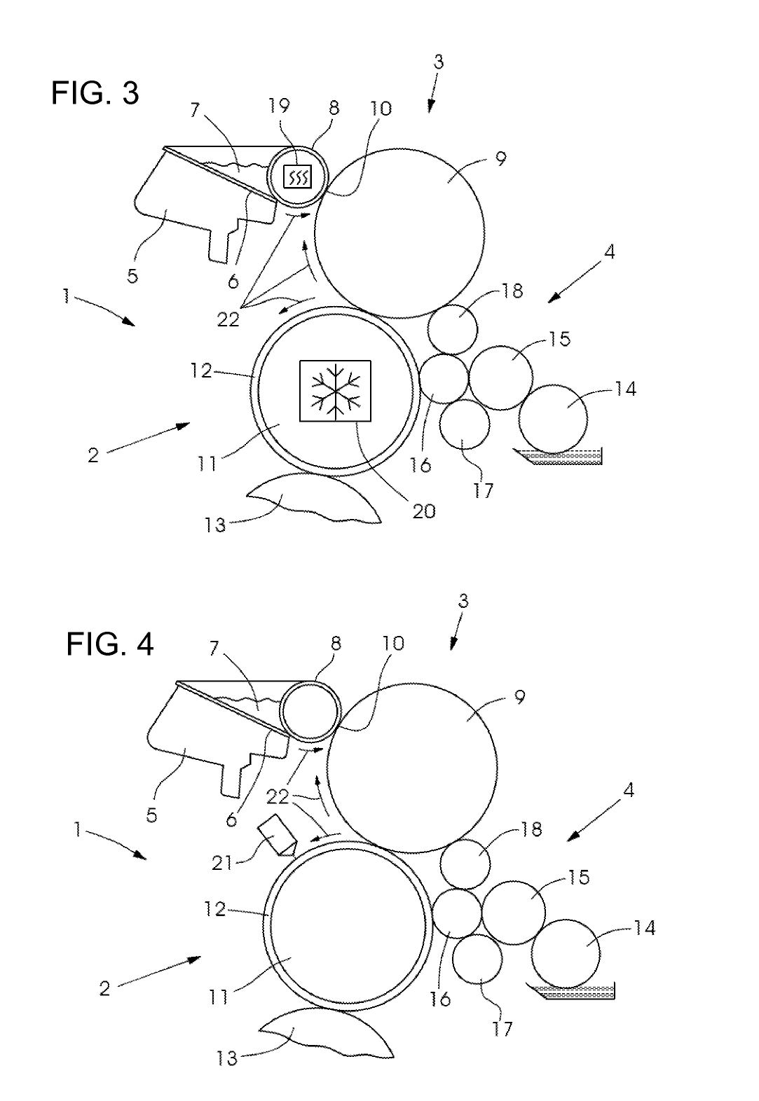

The exemplary embodiment shown in FIG. 3 is a combination of the exemplary embodiments shown in FIGS. 1 and 2. A heating device 19 for the ink fountain roller 8 and a cooling device 20 for the printing form cylinder 11 are present. In this example, the temperature difference between the printing ink 7 in the ink fountain 5 and the same printing ink on the printing form cylinder 11, i.e. on the offset printing form 12 mounted thereon, and the difference in viscosity resulting from the temperature difference is caused by heating the printing ink 7 in the ink fountain 5 through the use of the heating device 19 and simultaneously cooling the printing ink on the printing form cylinder 11 through the use of the cooling device 12.

In the exemplary embodiment shown in FIG. 4, a radiation source 21 is directed to a circumferential region of the printing form cylinder 11. As viewed in the direction of rotation of the printing form cylinder 11, the radiation source 21 is downstream of the inking unit roller 9 and upstream of the blanket cylinder 13. The radiation source 21 emits radiation towards the printing ink that has been applied by the inking unit roller 9 to the printing form cylinder 11, i.e. to the offset printing form 12 mounted thereon, to increase the viscosity of the ink. The viscosity of the printing ink present on the printing form cylinder is increased by the radiation source to a level above the viscosity of the same printing ink in the ink fountain 5 or as it is metered by the zonal ink metering device 6.

If the printing ink 7 processed in the offset printing unit 2 is a UV ink and contains UV photoinitiators, the radiation source 21 may be a UV radiator, for instance a UV laser. The UV radiation emitted by the radiation source 21 results in a partial cross-linking in the surface of the printing ink on the printing form cylinder 11, thus increasing the viscosity of the printing ink.

The printing ink 7 that is processed in the offset printing unit 2 may likewise include IR absorbers or NIR absorbers. In this case, the radiation source 21 is a respective IR emitter or a NIR emitter. The radiation emitted by the radiation source 21 heats the printing ink 7 on the printing form cylinder 11 to evaporate specific components of the printing ink or to volatilize them in an accelerated way. The result is an increased viscosity of the printing ink on the printing form cylinder 11.

1. A printing method for a printing press, the printing method comprising the following steps:
zonally metering a printing ink at a first viscosity with a metering device; and
transferring the printing ink at a second viscosity, being greater than the first viscosity, with a printing form cylinder.

2. The printing method according to claim 1, wherein the second viscosity is greater than the first viscosity at least by a factor of 10.

3. The printing method according to claim 2, wherein the first viscosity is less than 1 pascal-second and the second viscosity is more than 10 pascal-seconds.

4. The printing method according to claim 1, which further comprises adjusting the first viscosity by reducing a viscosity of the printing ink in the printing press.

5. The printing method according to claim 4, which further comprises carrying out the step of reducing the viscosity of the printing ink by at least one of the following steps a)-g):
a) heating the printing ink with a heating device;
b) heating the printing ink with a heating device of a fountain roller;
c) subjecting the printing ink to ultrasound treatment;
d) adding water or dampening fluid to the printing ink;
e) adding droplets of water or dampening fluid to the printing ink;
f) subjecting the printing ink to mechanical stress; and
g) subjecting the printing ink to mechanical stress by kneading or shearing.

6. The printing method according to claim 1, which further comprises adjusting the second viscosity of the printing ink by increasing the viscosity of the printing ink in the printing press.

7. The printing method according to claim 6, which further comprises carrying out the step of increasing the viscosity of the printing ink by at least one of the following steps h)-r):
h) cooling the printing ink with a cooling device;
i) cooling the printing ink with a cooling device of the printing form cylinder;
j) subjecting the printing ink to an electrorheological treatment;
k) evaporating a low-viscosity component of the printing ink;
l) evaporating a low-viscosity carrier liquid of the printing ink;
m) precipitating a component of the printing ink;
n) cross-linking a component of the printing ink;
o) subjecting the printing ink to UV radiation;
p) subjecting the printing ink to UV radiation from a laser;
q) subjecting the printing ink to IR radiation;
r) subjecting the printing ink to IR radiation from a laser;
s) subjecting the printing ink to NIR radiation; and
t) subjecting the printing ink to NIR radiation from a laser.

8. An offset printing unit, comprising:
an ink fountain having a metering device with ink zones;
an ink fountain roller with a heating device;
an inking unit roller in continuous engagement with said ink fountain roller; and
a printing form cylinder;
said ink fountain roller and said printing form cylinder being driven at the same circumferential speed.

9. The offset printing unit according to claim 8, wherein said heating device is configured to implement the printing method according to claim 1.

10. An offset printing unit, comprising:
an ink fountain having a metering device with ink zones;
an ink fountain roller;
an inking unit roller in continuous engagement with said ink fountain roller; and
a printing form cylinder having a cooling device;
said ink fountain roller and said printing form cylinder being driven at the same circumferential speed.

11. The offset printing unit according to claim 10, wherein said cooling device is configured to implement the printing method according to claim 1.

12. An offset printing unit, comprising:
an ink fountain having a metering device with ink zones;
an ink fountain roller with a heating device;
an inking unit roller in continuous engagement with said ink fountain roller; and
a printing form cylinder with a cooling device;
said ink fountain roller and said printing form cylinder being driven at the same circumferential speed.

13. The offset printing unit according to claim 12, wherein said heating device and said cooling device are configured to implement the printing method according to claim 1.
